(19) United States
(12) Patent Application Publication
(10) Pub. No.: US 2014/0244674 A1
(43) Pub. Date: Aug. 28, 2014

(54) ON-DEMAND NORMALIZATION OF DATA

(71) Applicant: MICROSOFT CORPORATION, Redmond, WA (US)

(72) Inventors: Adam Mollis, Seattle, WA (US); Mark Leece, Bellevue, WA (US)

(73) Assignee: MICROSOFT CORPORATION, Redmond, WA (US)

(21) Appl. No.: 13/779,556

(22) Filed: Feb. 27, 2013

(51) Int. Cl. G06F 17/30

(52) U.S. Cl. CPC G06F 17/30569
USPC 707/756

(57) ABSTRACT

A method for normalizing data for a user interface on an on-demand basis includes receiving data in a first format, and comparing the first format to a standard format. The method further includes receiving a request to present a first subset of the data but not a second subset of the data. Responsive to receiving the request to present the first subset of the data, if the first format is different from the standard format, the method further includes transforming the first subset of the data from the first format to the standard format without transforming the second subset of the data from the first format to the standard format. The method also includes presenting the first subset of the data with the standard format.

### BACKGROUND

Data may originate from multiple sources and may be in multiple different formats. A user may interact with the data via a user interface; however, such differences in formats may result in a non-unified appearance of the data when presented to the user.

### SUMMARY

A method for normalizing data for a user interface on an on-demand basis includes receiving data in a first format, and comparing the first format to a standard format. The method further includes receiving a request to present a first subset of the data but not a second subset of the data. Responsive to receiving the request to present the first subset of the data, if the first format is different from the standard format, the method further includes transforming the first subset of the data from the first format to the standard format without transforming the second subset of the data from the first format to the standard format. The method also includes presenting the first subset of the data with the standard format.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a non-limiting example of a computing environment for providing normalized data for a user interface in accordance with an embodiment of the present disclosure.

FIG. 2 shows an example method of normalizing data for a user interface in accordance with an embodiment of the present disclosure.

FIGS. 3A and 3B schematically show normalization systems for normalizing data for a user interface in accordance with an embodiment of the present disclosure.

FIG. 4 shows an example method of transforming data for normalizing data for a user interface in accordance with an embodiment of the present disclosure.

FIG. 5 shows an example normalized user interface in accordance with an embodiment of the present disclosure.

FIG. 6 shows an example normalized user interface presented during a user scrolling event in accordance with an embodiment of the present disclosure.

FIG. 7 shows a block diagram of an augmented object in accordance with an embodiment of the present disclosure.

FIG. 8 shows an example normalized JSON object in accordance with an embodiment of the present disclosure.

FIG. 9 is an example computing system in accordance with an embodiment of the present disclosure.

### DETAILED DESCRIPTION

Maintaining a consistent appearance of a user interface may provide a positive and efficient environment for user interaction with data on a computing device. However, data may originate from various sources, may be formatted differently, and/or may include incomplete elements. Further, attempts to reformat the data may be cumbersome and costly with respect to time and/or usage of resources such as processors, storage devices, communication media, etc. For example, some approaches to normalizing data involve using a Model, View, View Model pattern in which each source data has its own view model. Such patterns do not identify a shape of a standard format and are difficult to maintain and update for new data sources and formats.

Thus, embodiments are disclosed for normalizing data for a user interface and data displayed therein by transforming and/or augmenting data on an as-requested basis. The just-in-time, on-demand environment of such normalization ensures that computing resources and time are only spent on processing data that is particularly requested for display in the user interface. Further, the data is transformed and/or augmented based on a declarative augmentation definition. The augmentation definition provides a highly customizable normalization layer for declaring a shape of a standard format and addressing differences between multiple data sources. Accordingly, data from multiple sources that has multiple formats may be processed efficiently and presented in a unified manner such that all data looks the same to a user and computing resources are conserved.

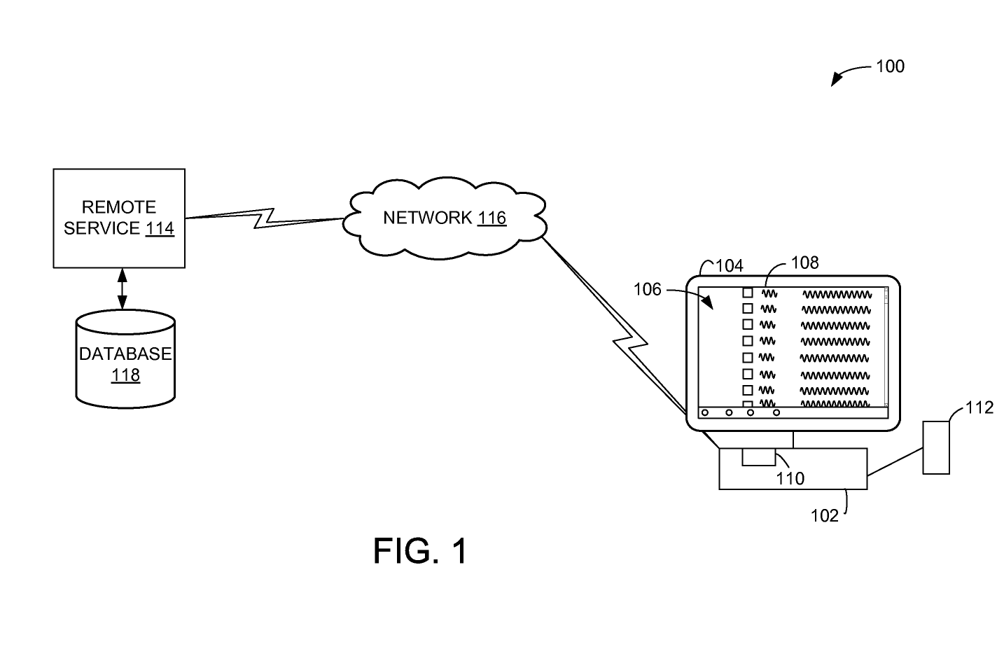

FIG. 1 shows an example computing environment 100 for providing the data normalization for a user interface as described herein. A computing device 102 is illustrated as being in communication with a display device 104 as well as multiple data sources. The display device 104 may be configured to display a user interface 106 via display 108. For example, the user interface 106 may be configured to allow a user of the computing device 102 to view and interact with a collection of media items and associated metadata. In such an example, the computing device 102 may receive and/or access data related to the media items and associated metadata and present the media items and associated metadata for viewing.

The computing device 102 may be in communication with an internal storage machine 110 and an external storage machine 112. For example, the internal storage machine 110 may be integrated or otherwise included within the computing device 102, while the external storage machine 112 may be local to the computing device but housed outside of the computing device. The computing device 102 may communicate with the external storage machine 112 via any suitable wired or wireless connection, including but not limited to Ethernet, FireWire, USB, SATA, WiFi, WiFi direct, Bluetooth, etc. The computing device 102 may also communicate with one or more remote services, such as a remote service 114, via a network 116. The remote service 114 may be any suitable remotely-located service and/or storage system. For example, the remote service 114 may be a media server corresponding to an online and/or cloud-based media store and/or entertainment application. Data may be stored at the remote service 114 and/or may be stored in one or more databases 118 associated with the remote service 114.

The computing device may receive data from one or more of the internal storage machine 110, the external storage machine 112, and the remote service 114 to populate the user interface 106. However, the data from any or all of the above-identified sources may be in a different format from one another and/or from a standard format utilized by the user interface 106. For example, the user interface 106 may display media items from a local database, such as a personal library of media items, from a remote service, such as an online store, and/or from a combination of a personal library and one or more online stores. Therefore, the data may be processed in a normalization layer by the computing device 102 when the data is requested for presentation in order to display the data in the same standard format within the user interface. Accordingly, a user may experience a seamless transition between viewing items in a personal library, from one or more online stores, and/or from a combination of a personal library and one or more online stores, as the content may be displayed in the same standard format across these environments.

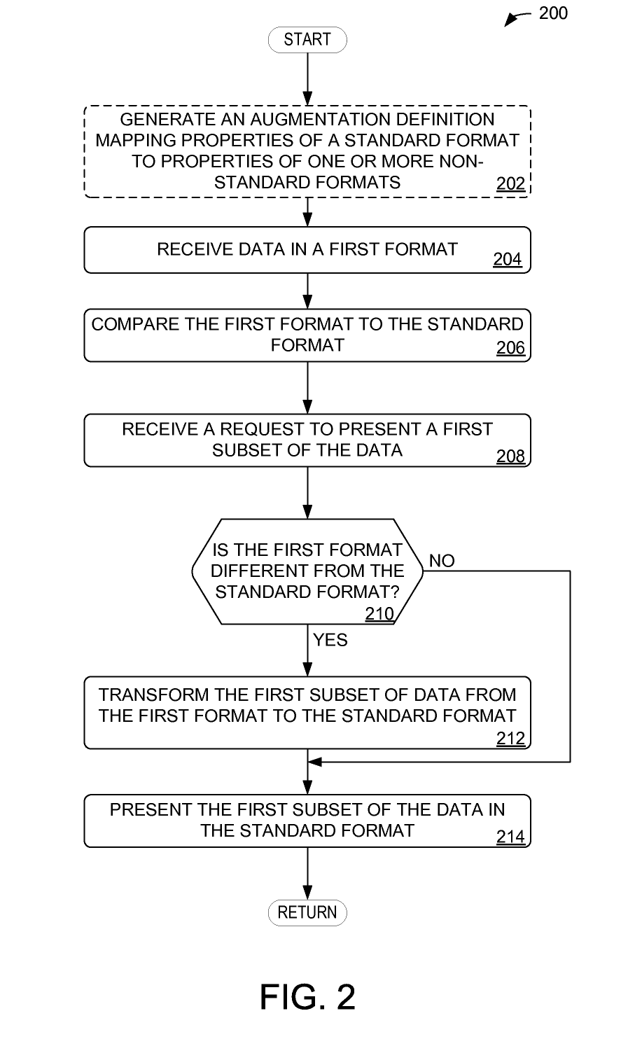

FIG. 2 shows an example method 200 of normalizing data for a user interface in accordance with an embodiment of the present disclosure. For example, the method 200 may be performed by the computing device 102 to present a normalized user interface 106. As indicated at 202, the method 200 may include generating an augmentation definition mapping properties of a standard format to properties of one or more non-standard formats. The augmentation definition may serve as a guide for processing data for display in a user interface by declaring a shape of the normalization layer and/or the standard format. The standard format, as well as any number of non-standard formats, may include one or more properties, each property having an associated property identifier or name and an associated value. Further, each value may be one of a plurality of possible value types and formats, including but not limited to arrays, strings, integers, etc.

Accordingly, the augmentation definition may map properties of a standard format to properties of one or more non-standard formats. For example, a property having the same property identifier in both the standard format and a non-standard format may have different value types. The associated value for the property may be in array in the non-standard format and may be one or more pages in the standard format. Therefore, when mapping the property identifier of the non-standard format to the corresponding identifier in the standard format, the two formats may be compared in order to determine whether the non-standard format is different from the standard format. Likewise, the augmentation definition may be utilized to determine whether a particular property is in a different format than the corresponding property in the standard format.

Continuing with FIG. 2, the method 200 includes receiving data in a first format at 204. The data may be received from any of a plurality of suitable sources, including but not limited to those described with respect to FIG. 1. For example, the data may be received from one or more local storage machines, one or more remote services, and/or any other suitable data source. The data received at 204 may be a set of data in any suitable format. In some embodiments, the set of data may include one or more JavaScript Object Notation (JSON) strings, which are immediately converted to JSON objects upon receipt and/or converted to JSON objects when requested to be used. The data may correspond to one or more media items and/or metadata associated with the one or more media items.

In embodiments where the data includes one or more objects, each of the one or more objects may have one or more associated properties. Additionally, each of the one or more associated properties may have a corresponding and/or associated property identifier and a corresponding and/or associated value. Thus, a subset of the data may correspond to a particular property or group of properties of the data and/or a particular object of the data. In some embodiments, the data may include one or more media items, and each property may correspond to a portion of metadata associated with the one or more media items.

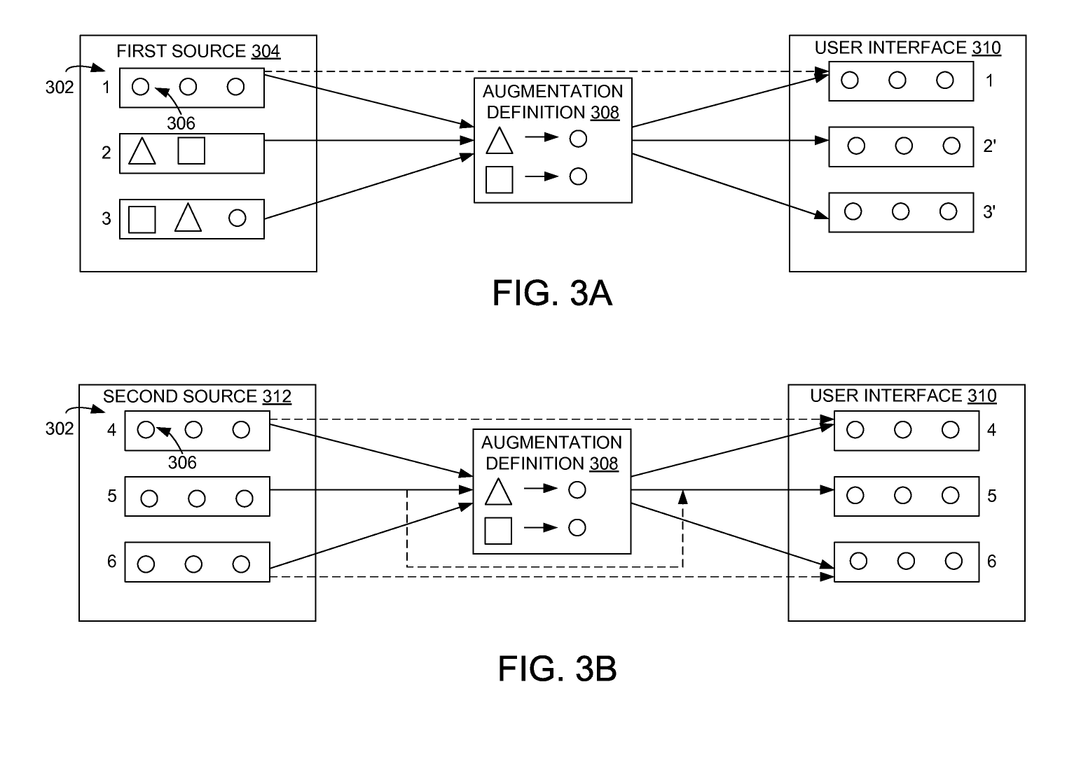

Turning briefly to FIGS. 3A and 3B, examples of a normalization system in accordance with embodiments of the present disclosure are schematically illustrated. One or more subsets of data 302 from a first source 304 are shown in FIG. 3A, each of the subsets of data 302 including one or more properties 306. The shapes of the properties 306 illustrate property identifiers, values, and/or value types associated with each of the properties 306. For the examples described herein, the circular shape shown in subset 1 of the data from the first source 304 corresponds to a property with a property identifier, value, and value type that adheres to a standard format.

Turning back to FIG. 2, the method 200 includes comparing the first format to the standard format, as indicated at 206. For example, the first format may be compared to the standard format by evaluating differences between the properties of the data in the first format and corresponding properties in the augmentation definition. As shown in FIGS. 3A and 3B, each of the subsets of data 302 optionally may be passed through an augmentation definition 308 to map the properties 306 to properties of the standard format.

The method 200 of FIG. 2 further includes receiving a request to present a first subset of data at 208. The request may include a request to present a first property of the first subset of data but not a second property of the first subset of data. For example, a user may provide user input to a user interface to scroll through a list of media items, such that a portion of the metadata for each media item is requested and presented as the user progresses through the list during scrolling. Accordingly, the user interface may only display one new media item at a time, and may display all or a portion of the metadata for that media item. Instead of processing the entire list of media items, the method 200 processes each subset of data as it is requested. Further, the request may be defined based on the data source being queried. For example, a request for data from a local storage machine may include different instructions than a request for data from a remote service.

Responsive to the request, the method 200 includes determining if the first format is different from the standard format, as indicated at 210. In some embodiments, this determination may be performed based on the comparison described at 206 and/or based on the augmentation definition. If the first format and/or the format of the subset of data is different from the standard format, the method 200 continues to 212, to transform the first subset of the data from the first format to the standard format. Other subsets of the data need not be transformed when the first subset of the data is transformed, regardless of a format associated with the first and/or other subsets of data, when the other subsets of data are not requested. The method 200 then presents the first subset of the data in the standard format, as indicated at 214, thereby presenting the transformed subset of data. However, if the first format and/or the format of the subset of data is the same as the standard format, the method 200 skips 212 and presents the first subset of the data in the standard format, as indicated at 214, without transforming the subset of data.

Turning back to FIGS. 3A and 3B, the transformation and presentation described above are schematically illustrated. As shown in FIG. 3A, the first source 304 includes subset 1, in which each parameter corresponds to a standard format. Therefore, when subset 1 is passed through the augmentation definition 308, no transformation is performed, and the unaltered subset 1 is presented at a user interface 310. As shown by the dashed line in FIG. 3A, if it is known that subset 1 is the same format as the standard format, the augmentation definition 308 may be bypassed in some embodiments, such that subset 1 is presented immediately upon request without consulting the augmentation definition 308.

In contrast, subset 2 illustrates a subset that includes only properties that are different from the standard format. As schematically shown in the augmentation definition 308, the squares and triangles representing property identifiers, values, and/or value types of a non-standard format may be mapped to circles representing property identifiers, values, and/or value types of a standard format. Accordingly, responsive to a request to present subset 2, the format is transformed to the standard format, and subset 2′, representing the transformed subset in the standard format, is presented at the user interface 310.

Subset 3 illustrates a subset that includes properties that are different from the standard format and a property that is the same as the standard format. Responsive to a request to present subset 3, the properties that are different from the standard format are transformed, while the property that is the same as the standard format is maintained. Therefore, subset 3′, which includes a transformed first and second property and an untransformed third property, is presented at the user interface 310.

FIG. 3B illustrates a normalization of a second source 312, from which data having the same format as the standard format is received. Accordingly, responsive to a request to present each of subsets 4, 5, and 6, the subsets are presented at the user interface 310 without transforming the properties. Further, as illustrated by the dashed lines in FIG. 3B, if it is known that the data from the second source is in the standard format one or more of the subsets may bypass the augmentation definition 308 upon receiving the request to present the subsets in some embodiments.

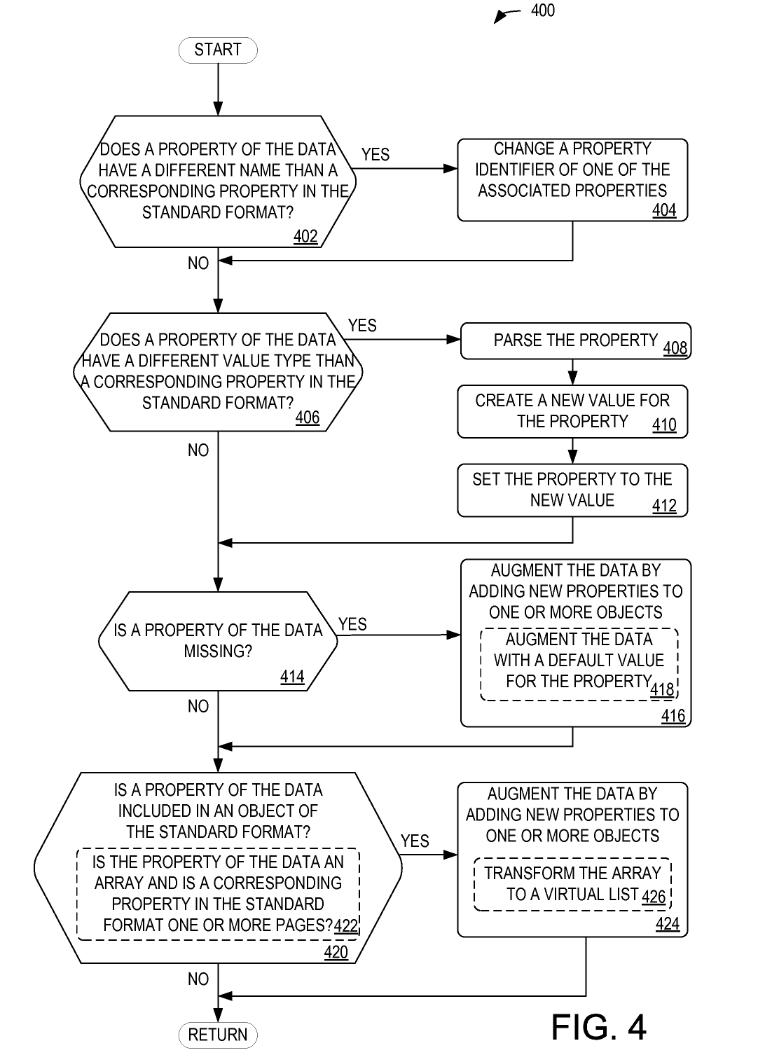

FIG. 4 illustrates a method 400 of identifying differences between a non-standard format and a standard format and associated transformations that are performed in response to the identified differences. For example, method 400 may be performed during step 212 of method 200, illustrated in FIG. 2. In particular, the method 400 may be performed responsive to receiving a request to present a subset of data. Any or all of the decision steps of FIG. 4 may be utilized to compare the format of the data to the standard format and/or to determine whether the format of the data is the same as or different from the standard format. For each decision step of FIG. 4, the “YES” path corresponds to a difference between the format of the data and the standard format.

The method 400 includes determining if a property of the data has a different name than a corresponding property in the standard format, as indicated at 402. In other words, a property of metadata associated with a media item may have a first property name that is similar to but different from a standard property name that is mapped to the first property name in an augmentation definition. If the property of the data has a different name than the corresponding property in the standard format, the method 400 includes performing an aliasing operation by changing a property identifier and/or name of the associated property without changing the value of the property associated with the changed property identifier.

For example, an original property identifier of “genre” in a first format may be mapped to a standard property identifier of “genreID” in the standard format in the augmentation definition. Responsive to determining this difference, the original property identifier of “genre” may be changed to “genreID” in order to normalize the data with the standard format. In some embodiments, the data may be transformed by augmenting the data with a new object that defines the standard property identifier as having a value associated with the original property identifier.

The method 400 further includes determining if a property of the data has a different value type than a corresponding property in the standard format to which the property of the data is mapped in an augmentation definition, as indicated at 406. If the value type is different, the method 400 continues to 408, which includes parsing the property to negotiate and/or identify information for converting the property to the standard format. Based on the parsing, a new value is created for the property and 410 and the property is set to this new value at 412.

For example, a first format and a standard format may have a property with the same identifier; however the first format may include a string value for the property, while the standard format may include an integer value for the property. Therefore, the property value of the first format may be converted from a string to an integer to comply with the standard format.

At 414, the method 400 includes determining if a property of the data and/or a value for a property of the data is missing. For example, the data may be missing a property of the standard format that is mapped by the augmentation definition. If a property of the data is determined to be missing, the method 400 includes augmenting the data by adding new objects and/or new properties to one or more objects, as indicated at 416. In some embodiments, such augmentation may include augmenting the data with a default value for the property, as indicated at 418. For example, as shown in FIG. 3A, a third property is missing from subset 2, therefore augmented subset 2′ is populated with a property and associated value corresponding to the standard format.

The method 400 further includes determining if a property of the data is included in an object of the standard format, as indicated at 420. The determination of 420 may further include determining if the property of the data is an array and a corresponding property in the standard format is one or more pages, as indicated at 422. If the property of the data is included in an object of the standard format, the method 400 includes augmenting the data by adding new objects and/or properties to one or more objects, as indicated at 424. The augmentation may include transforming the array to a virtual list, as indicated at 426. Further, once an object is augmented, it may be deflated to an original state, such that any and/or all added properties are removed.

As discussed above, the data may correspond to one or more media items and/or metadata corresponding thereto. For example, a user may have media items stored on a local storage machine, and a remote service may provide media items for purchase and/or consumption. The user may view, purchase, and/or otherwise interact with media items originating from these and any other suitable sources within the same user interface. However, one of the sources may provide media items having different formats from one or more of the other sources. Further, media items within a single source may have different formats from one another. Any or all of these different formats may also be different from a standard format utilized in a user interface for interacting with the differently-sourced media items. If left unaddressed, the user interface may not have a unified appearance and/or may not display all of the information associated with each of the media items.

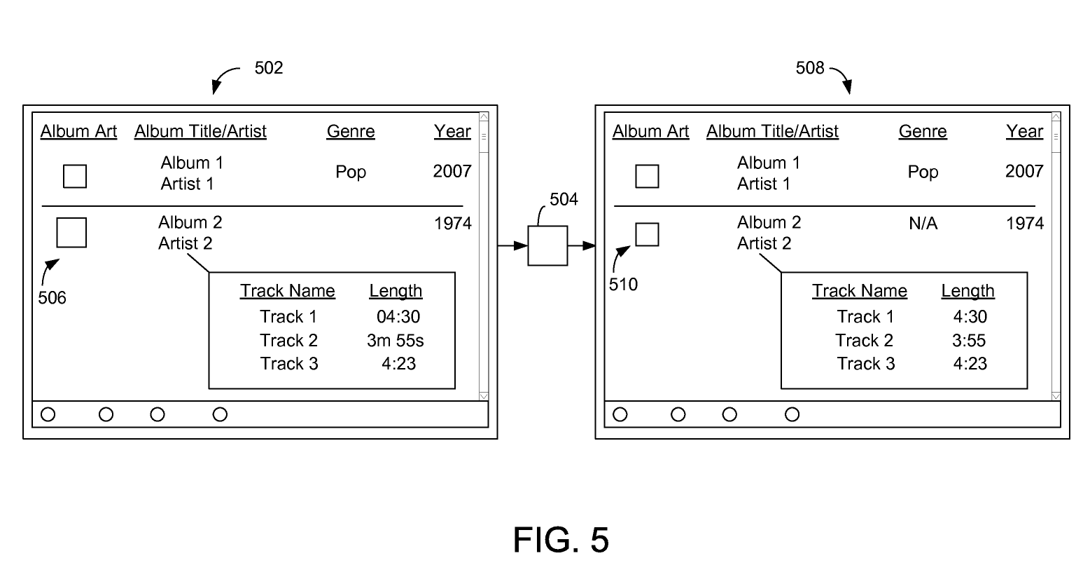

FIG. 5 shows an example of normalizing data for a user interface displaying a plurality of media items and associated metadata in accordance with an embodiment of the present disclosure. A first user interface 502 illustrates an appearance of data having a different format than a standard format. In other words, the user interface 502 may correspond to an appearance of data if the data were to be presented prior to being transformed in accordance with an augmentation definition 504. The user interface 502 includes a plurality of visual representations 506 of metadata as originally formatted. As shown, a value for the genre of album 2 is missing, the album art of albums 1 and 2 are different sizes, and the track lengths are presented in different formats. These are just some of the examples of a non-unified user interface that may negatively affect a user's experience when interacting with data. It is to be understood that the various displayed media items may be provided by different sources (e.g., local storage machine and/or different remote services).

User interface 508 illustrates an appearance of a normalized user interface, after the data is transformed in accordance with the augmentation definition 504. As shown, a plurality of visual representations 510 of metadata are presented with a unified appearance for ease of viewing and interaction. For example, the album art is resized to match one another, the missing genre field is populated with a default value, and the track lengths are standardized to the same format.

In the example of FIG. 5, multiple properties may be updated for presentation in the user interface 508. As discussed above, augmentations and/or transformations for data may be performed on-demand, such that data is only changed in response to a request to present the data. Therefore, the example of FIG. 5 may illustrate an example in which all metadata is requested at substantially the same time; therefore all metadata having a different format from a standard format is transformed and presented at substantially the same time. However, if a user scrolls through a list of media items, one or more portions of the metadata associated with the media items may not be presented to the user during scrolling. Therefore, only a portion of the metadata may be requested for presentation and subsequently normalized.

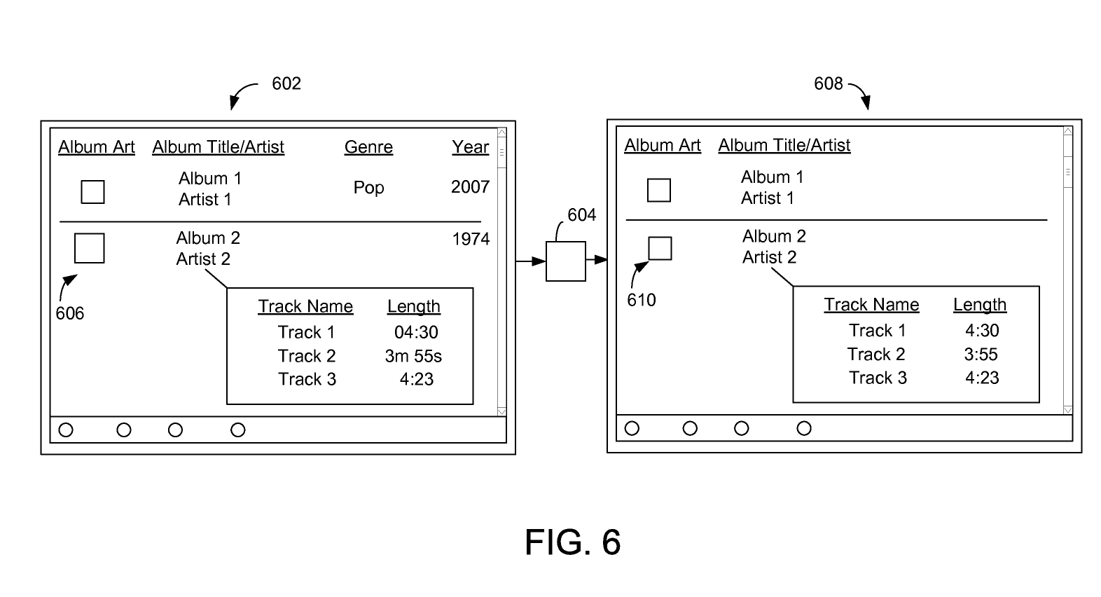

FIG. 6 shows an example of data normalization for a user interface during a scrolling event to illustrate selective transformation and presentation of data. The first user interface 602, augmentation definition 604, and visual representations 606 of metadata as originally formatted correspond to the similarly depicted elements of FIG. 5 and are described in more detail above. However, in the example provided in FIG. 6, the user interface 608 corresponds to a condensed version of the user interface while a user is scrolling through a list of media items.

As shown in FIG. 6, visual representations 610 of metadata having a unified appearance are present for some of the corresponding visual representations 606 of metadata as originally formatted. For example, the album art is resized and track lengths are reformatted to match one another in the user interface 608. However, during scrolling, some data, such as genre and year in the example of FIG. 6, may not be displayed. Since these items are not displayed, the genre and year metadata items for each of the media items are not requested. Accordingly, even though the genre is missing from album 2, this element of the metadata is not transformed in the manner described with respect to FIG. 5, or in any other manner. Such selective augmentation may conserve resources and decrease time delays in comparison to augmentation that is performed on all data and/or upon receipt of data.

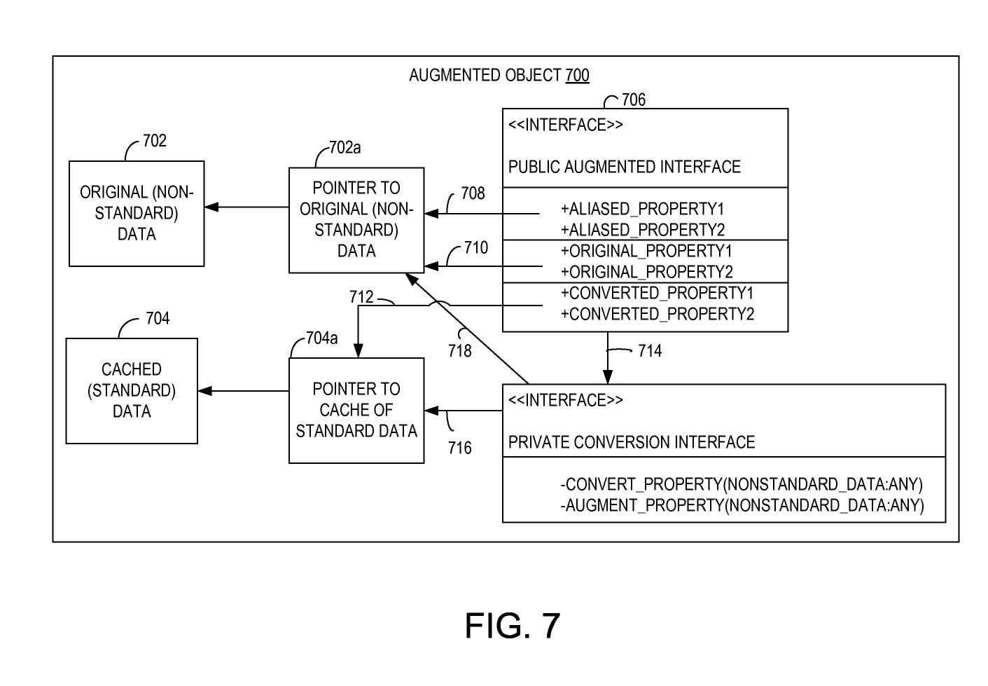

FIG. 7 is a block diagram of an augmented object 700 in accordance with an embodiment of the present disclosure. As illustrated, the augmented object 700 has three components: a first object 702 used for storing the original (non-standard) data, a second object 704 used to cache computed (standard) data which is calculated on-demand, and public interfaces 706 that expose the augmented (standard) properties. The augmented object 700 may include a pointer 702a to a storage location of the original data and a pointer 704a to a storage location of the cache computed data. By storing the original (non-standard) data in the first object 702, this information is maintained such that the augmented object may be deflated to its original state. By caching the on-demand computed (standard) data in the second object 704, the need to recalculate the standard data is eliminated. Next, the public interfaces 706 are wrappers around the standard data.

As shown at 708 and 710, these interfaces 706 pull data from the non-standard data store if no conversion is needed, such as when interfacing aliased or original properties. As shown at 712, these interfaces 706 may also pull data from the cache if a conversion was already executed for the standard data, such as when interfacing converted properties. Finally, if a conversion is needed but has not been executed for the standard data, these interfaces 706 execute a conversion, as shown at 714, and store the result in the standard data cache, as shown in 716. The conversion interface may access the original data to perform the conversion, as indicated at 718.

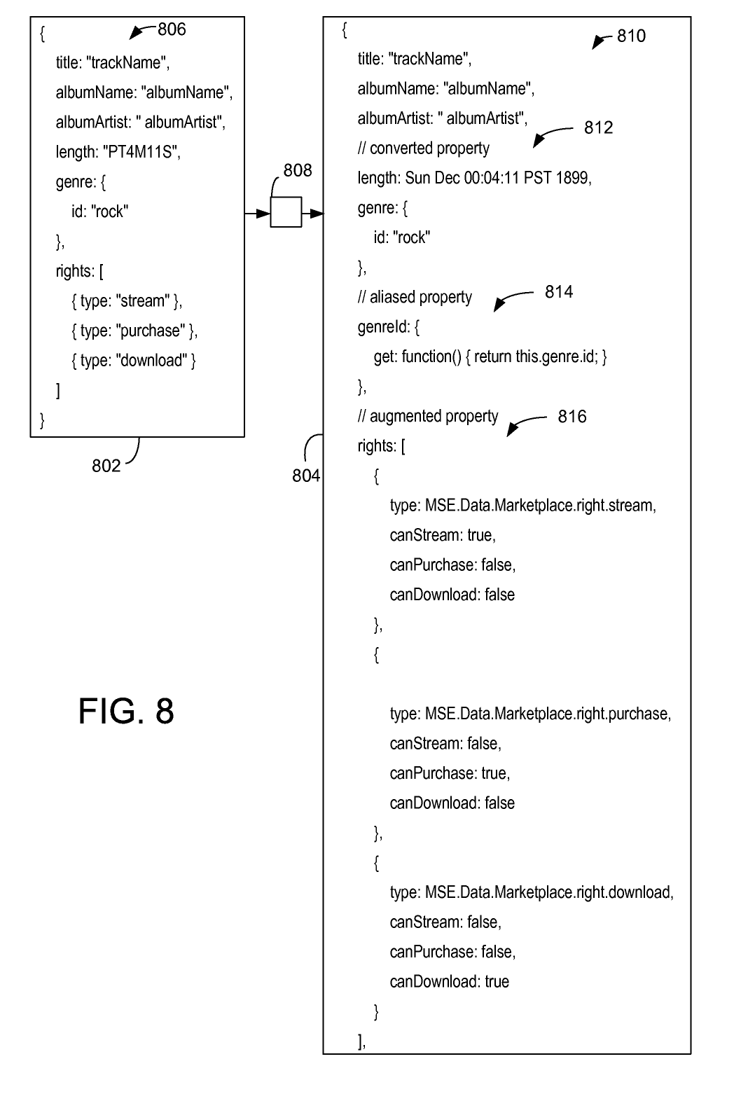

FIG. 8 illustrates an example of an original JSON object 802 and an augmented JSON object 804 in accordance with an embodiment of the present disclosure. The original JSON object 802 includes a plurality of original properties 806, such as title, album name, album artist, length, etc. Taking the length property as an example, the property identifier for this property is “length” and the property value is “PT4M11S.” However, an augmentation definition 808 may include a standard length property mapped to the length property that has a value type that is different than the value type of the length property in the original JSON object 802.

Similarly to the original JSON object 802, the augmented JSON object 804 includes a plurality of properties 810. However, some of the properties 810 are transformed versions of the original properties 806. For example, as shown at 812, the length property is converted from the value “PT4M11S” to the value “Sun Dec 00:04:11 PST 1899” based on the augmentation definition 808. As shown at 814, the genreID property is aliased, since the original JSON object 802 includes a genre property with a different property identifier. Therefore, the genreID of the augmented JSON object 804 has a value defined by the genre of the original JSON object 802. As shown at 816, some properties may be augmented by paging. The rights property of the original JSON object 802 is an array of values; however the standard format may present the same property as a collection of pages. In the augmented JSON object 804, therefore, a virtual list is provided, where each entry in the list is a right.

In accordance with the present disclosure, a subset of data received at a computing device may be transformed to correspond to a standard format on an as-needed basis. By only transforming data when the data is requested to be presented a user interface may maintain a unified appearance, yet processing overhead may be decreased in comparison with configurations that transform data without regard to such a request.

In some embodiments, the methods and processes described herein may be tied to a computing system of one or more computing devices. In particular, such methods and processes may be implemented as a computer-application program or service, an application-programming interface (API), a library, and/or other computer-program product.

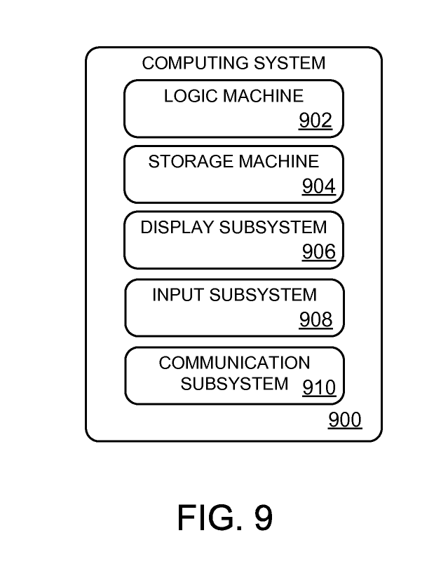

FIG. 9 schematically shows a non-limiting embodiment of a computing system 900 that can enact one or more of the methods and processes described above. Computing system 900 is shown in simplified form. Computing system 900 may take the form of one or more control devices, gaming consoles, personal computers, server computers, tablet computers, home-entertainment computers, network computing devices, mobile computing devices, mobile communication devices (e.g., smart phone), and/or other computing devices. For example, computing system 900 may include computing device 102 and/or remote service 114 of FIG. 1. Furthermore, computing system 900 may be configured to computationally execute the augmentation definitions described herein.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold and/or store machine-readable instructions executable by the logic machine to implement the methods and processes described herein. For example, logic machine 902 may be in operative communication with storage machine 904. When such methods and processes are implemented, the state of storage machine 904 may be transformed—e.g., to hold different data. Storage machine 904 may correspond to local storage machine 110 of FIG. 1.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include machine-readable volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 906 may be used to present a visual representation of data held by storage machine 904. This visual representation may take the form of a graphical user interface (GUI), such as user interfaces 310, 508, 608, etc. As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices. For example, display subsystem 906 may include display device 104 of FIG. 1.

When included, input subsystem 908 may comprise or interface with one or more user-input devices such as a keyboard, mouse, touch screen, microphone, or game controller. For example, input subsystem may include or interface with computing device 102 of FIG. 1. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of on-demand normalization of data for a user interface, the method comprising:
receiving the data in a first format;
comparing the first format to a standard format;
receiving a request to present a first subset of the data but not a second subset of the data;
responsive to receiving the request to present the first subset of the data, if the first format is different from the standard format, transforming the first subset of the data from the first format to the standard format without transforming the second subset of the data from the first format to the standard format; and
presenting the first subset of the data in the standard format.

2. The method of claim 1, wherein responsive to receiving the request to present the first subset of the data, if the first format is the same as the standard format, presenting the first subset of the data in the standard format.

3. The method of claim 1, wherein the data includes one or more objects, each of the one or more objects having one or more associated properties, and each of the one or more associated properties having a corresponding property identifier and a corresponding value.

4. The method of claim 3, wherein transforming the first subset of the data from the first format to the standard format includes changing a property identifier of one of the associated properties without changing a value of the one of the associated properties corresponding to the property identifier.

5. The method of claim 3, wherein transforming the first subset of the data from the first format to the standard format includes parsing one of the one or more associated properties, creating a new value for the one of the one or more associated properties, and setting the one of the one or more associated properties to the new value.

6. The method of claim 3, wherein transforming the first subset of the data from the first format to the standard format includes augmenting one of the one or more objects by adding new properties to the one of the one or more objects.

7. The method of claim 1, wherein the first subset of the data includes one or more JavaScript Object Notation (JSON) objects.

8. The method of claim 1, wherein the data is received from a remote service.

9. The method of claim 1, wherein the data is received from a local storage machine.

10. The method of claim 1, wherein the standard format includes one or more properties, the method further comprising generating an augmentation definition mapping properties of the standard format to properties of one or more non-standard formats.

11. The method of claim 10, wherein transforming the first subset of the data from the first format to the standard format includes determining that the first subset of the data is missing a property of the standard format mapped by the augmentation definition, and augmenting the first subset of the data with a default value for the property of the standard format defined by the augmentation definition.

12. A computing device for providing a user interface to a display device, the computing device comprising:
a logic machine; and
a storage machine storing instructions executable by the logic machine to:
receive a first set of data in a first format from a first source;
receive a first request to present a first subset of the first set of data but not a second subset of the first set of data;
responsive to receiving the first request, if the first format is different from a standard format:
transform the first subset of the first set of data from the first format to the standard format without transforming the second subset of the first set of data from the first format to the standard format, and
present the first subset of the first set of data in the user interface in the standard format;
receive a second set of data in a second format from a second source;
receive a second request to present a first subset of the second set of data but not a second subset of the second set of data; and
responsive to receiving the second request, if the second format is the same as the standard format:
present the first subset of the second set of data in the user interface without transforming the first subset of the second set of data.

13. The computing device of claim 12, wherein the first source is the storage machine and the second source is a remote service.

14. The computing device of claim 12, wherein the first set of data includes a parameter having an associated value, wherein the associated value is an array in the first format and is one or more pages in the standard format, and wherein transforming the first subset of the first set of data includes transforming the array of the first subset of the first set of data to a virtual list.

15. A method of on-demand normalization of data for a user interface, the method comprising:
generating an augmentation definition mapping properties of a standard format to properties of one or more non-standard formats;
receiving one or more local media items having a first set of metadata in a first format from a local storage machine;
receiving a first request to present a first property of the first set of metadata but not a second property of the first set of metadata;
responsive to receiving the first request, if the first format is different from the standard format, transforming the first property of the first set of metadata from the first format to the standard format based on the augmentation definition, without transforming the second property of the first set of metadata from the first format to the standard format, and presenting the first property of the first set of metadata in the user interface in the standard format;
receiving one or more remote media items having a second set of metadata in a second format from a remote service;
receiving a second request to present a first property of the second set of metadata but not a second property of the second set of metadata; and
responsive to receiving the second request, if the second format is the same as the standard format, presenting the first property of the second set of metadata in the user interface without transforming the first property of the second set of metadata.

16. The method of claim 15, further comprising determining that the first format is different from the standard format by determining that the first property of the first set of metadata has a different name than a property of the standard format that is mapped to the first property of the first set of metadata in the augmentation definition.

17. The method of claim 15, further comprising determining that the first format is different from the standard format by determining that the first property of the first set of metadata has a different value type than a property of the standard format that is mapped to the first property of the first set of metadata in the augmentation definition.

18. The method of claim 15, further comprising determining that the first format is different from the standard format by determining that the first property of the first set of metadata is missing from the first set of metadata.

19. The method of claim 15, further comprising determining that the first format is different from the standard format by determining that the first property of the first set of metadata is included in an object of the standard format.

20. The method of claim 15, wherein receiving a first request to present a first property of the first set of metadata but not a second property of the first set of metadata comprises receiving a user input to scroll a list of media items, and wherein only a portion of metadata associated with each of the media items in the list is presented during scrolling.
